(19) United States
(12) Patent Application Publication
(10) Pub. No.: US 2020/0380067 A1
(43) Pub. Date: Dec. 3, 2020

(54) CLASSIFYING CONTENT OF AN ELECTRONIC FILE

(71) Applicant: Microsoft Technology Licensing, LLC, Redmond, WA (US)

(72) Inventors: Tomasz Lukasz RELIGA, Seattle, WA (US); Marian Kimberley CHUA, Bellevue, WA (US); Huitian JIAO, Redmond, WA (US); David Benjamin LEE, Sammamish, WA (US); Manan SANGHI, Bellevue, WA (US)

(21) Appl. No.: 16/426,305

(22) Filed: May 30, 2019

(51) Int. Cl. G06F 17/21; G06N 20/00

(52) U.S. Cl. CPC G06F 17/212; G06N 20/00

(57) ABSTRACT

Systems and methods for classifying content of an electronic file. One system includes an electronic processor configured to determine a content type associated with a portion of content included in the electronic file using a classification model developed using machine learning. The electronic processor is also configured to determine a suggested modification for the portion of content based on the determined content type. The suggested modification is a modification to a format property of the portion of content. The electronic processor is also configured to provide a notification of the suggested modification to a user for acceptance of the suggested modification. In response to the user accepting the suggested modification, the electronic processor is configured to modify the format property of the portion of content in accordance with the suggested modification.

### FIELD

Embodiments described herein relate to content creation methods and systems and automatically classifying content of an electronic file, such as a paragraph type of typed text, using a model created using machine learning. A determined content type for content is used to modify various formatting parameters of the content, such as, for example, font, font size, paragraph spacing, or the like. In some embodiments, the content type determination is performed as a real-time text analysis system (for example, as a user types within an electronic document) and notifies a user of suggested modifications (formatting modifications) based on determined content types, which a user can browse and accept as desired, or automatically applies the suggested modifications.

### SUMMARY

Word or content processing applications, such as Word® provided by Microsoft Corporation, allow users to create electronic files (word documents). These content processing applications often provide a document styling tool for formatting content (for example, body text, title, heading, abstract, images, and the like) included in an electronic file. However, most users do not use document styling tools when creating an electronic file. Additionally, users tend to borrow formatted content from a variety of sources, such as the Internet, other electronic files, and the like. For example, a user may add content from a first source and content from a second source, where the content from the first source is formatted differently than the content from the second source for the same type of content. Accordingly, when the user combines this content into a single electronic file, the electronic file has inconsistent formatting across portions of content included in the electronic file. For example, each portion of content may be in a different font or in a different sized font. As a result, a user needs to manually modify a format property associated with one or more portions of content included in the electronic file. For example, a user may manually modify a format property, such as a font, for a portion of content to denote a title, a byline, one or more heading levels, and the like. In some instances, the manual modifications to format properties across various portions of content included in an electronic file causes mis-matches in formatting properties for the portions of content of the given content type, which, ultimately, leads to unprofessionally looking electronic files. Additionally, the manual implementation typically results in a user applying a style (for example, a Heading 1 style) from a toolbar (for example, a Home Tab), replacing a format property (for example, making a font larger, bold, italic, and the like) for each portion of content included in the electronic file, adding LaTeX or HTML tags, such as \section or <h1> to the electronic file, or a combination thereof, which can waste not only user time but also computing resources. Furthermore, electronic files with inaccurate or missing properties can limit the use of the electronic files in various searching, mining, machine learning, and other automated processing systems and methods.

Additionally, when a user directly formats a portion of content (by manually modifying one or more format properties), a semantic intent of the user with respect to the manually formatted portion of content generally cannot be determined. However, when a user selects a style, such as “Heading 1,” the semantic intent of the user with respect to the portion of content selected as “Heading 1” is identified. Having knowledge of the semantic intent of the user with respect to one or more portions of content enables additional functionality within the electronic file. For example, the semantic intent associated with one or more portions of content may be used to create a Table of Contents or a hierarchical navigation pane that includes headings. Accordingly, when this semantic intent is missing from an electronic document, functionality within the electronic file is limited.

To address these and other problems, embodiments described herein detect a content type associated with a portion of content included in an electronic file, and, more particularly, a content type associated with text included in an electronic document. The detected content type may be used to modify a format property in a consistent way, layout the electronic file more professionally, provide navigational guidelines within the electronic file, set one or more tags (for example, a title or an author) for the electronic file (or portions of content therein), identify a semantic intent of an author, or a combination thereof.

In some embodiments, a content type associated with a portion of content included in an electronic file is detected using artificial intelligence (for example, via a classification model developed using machine learning). In some embodiments, existing documents (electronic files), websites, and databases are analyzed using one or more machine learning techniques to determine whether a portion of content (for example a paragraph of text) represents a particular content type, such as a title, an abstract, a heading, a paragraph, or another element in the electronic file and build a corresponding mode. Thus, once trained, the model can be applied to electronic files to automatically determine content types and, in some embodiments, automatically apply content types and associated formatting characteristics or properties.

Some embodiments described herein also provide real-time text analysis systems and methods that provide content type information to a user while the user enters content into an electronic file and allow the user to apply one or more suggested modifications to a specific portion of content. Alternatively or in addition, in some embodiments, the user may browse multiple suggested modifications, such as document themes or document layouts, and apply a suggested modification to the entire electronic file (all portions of content of the electronic file).

Accordingly, embodiments described herein provide systems and methods for classifying content of an electronic file. One embodiment provides a system of classifying content of an electronic file. The system includes an electronic processor configured to determine a content type associated with a portion of content included in the electronic file using a classification model developed using machine learning. The electronic processor is also configured to determine a suggested modification for the portion of content based on the determined content type. The suggested modification is a modification to a format property of the portion of content. The electronic processor is also configured to provide a notification of the suggested modification to a user for acceptance of the suggested modification. In response to the user accepting the suggested modification, the electronic processor is configured to modify the format property of the portion of content in accordance with the suggested modification.

Another embodiment provides a method of classifying content of an electronic file. The method includes receiving, with an electronic processor, a training set, the training set including a plurality of electronic files. One or more portions of content included in each of the plurality of electronic files is associated with one of a plurality of content types. The method also includes generating, with the electronic processor, a classification model using machine learning and the training set. The method also includes receiving, with the electronic processor, a new electronic file and determining, with the electronic processor, a content type for a portion of content included in the new electronic file using the classification model. The method also includes determining, with the electronic processor, a suggested modification for the portion of content based on the content type. The method also includes providing, with the electronic processor, a notification of the suggested modification to a user for acceptance of the suggested modification. The method also includes, in response to the user accepting the suggested modification, modifying the portion of content in accordance with the suggested modification.

Yet another embodiment provides a non-transitory, computer-readable medium including instructions that, when executed by an electronic processor, cause the electronic processor to execute a set of functions. The set of functions includes detecting a user interaction with an electronic file by a user. The user interaction includes adding a portion of content to the electronic file. The set of functions also includes, in response to detecting the user interaction, applying a real-time classification model developed using machine learning to determine a content type associated with the portion of content. The set of functions also includes determining a modification for the portion of content based on the content type and applying the modification to the portion of content.

### BRIEF DESCRIPTION OF THE DRAWINGS

FIG. 1 schematically illustrates a system for classifying content of an electronic file according to some embodiments.

FIG. 2 is a flowchart illustrating a method of classifying content of an electronic file according to some embodiments.

FIGS. 3A-3B illustrate a sample electronic file according to some embodiments.

FIGS. 4A-4C illustrate a sample graphical user interface including one or more suggested modifications for content of the electronic file of FIGS. 3A-3B according to some embodiments.

FIG. 5 illustrates a sample graphical user interface including one or more suggested modifications for all portions of content of the electronic file of FIGS. 3A-3B.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory, computer readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As described above, content processing applications allow users to create an electronic file (in example, an electronic document, such as a word document). Word or content processing applications often provide a document styling tool for formatting content (for example, body text, title, heading, abstract, images, and the like) included in an electronic file. However, most users do not use document styling tools when creating an electronic file. Additionally, users tend to borrow formatted content from a variety of sources, such as the Internet, other electronic files, other text files, and the like. As noted above, this results in inconsistent formatting across portions of content included in the electronic file. As a result, a user needs to manually modify a format property associated with one or more portions of content included in the electronic file, which is still prone to errors and wastes both user time and computing resources. Furthermore, as noted above, improperly formatted electronic files can limit the use of such files in automated processing system.

To address these and other problems with consistent formatting across portions of content included in an electronic file, embodiments described herein detect a content type associated with a portion of content included in an electronic file, and, more particularly, a content type associated with text included in an electronic file. The detected content type may be used to modify a format property in a consistent way, layout the electronic file more professionally, provide navigational guidelines within the electronic file, set one or more tags (for example, a title or an author) for the electronic file (or portion of content therein), or a combination thereof.

It should be understood that the “portions” of an electronic file are described herein using paragraphs of text as one example. However, a portion may represent other elements of an electronic file, such as, for example, pages, slides, sheets, sentences, phrases, individual words, images, charts, or the like.

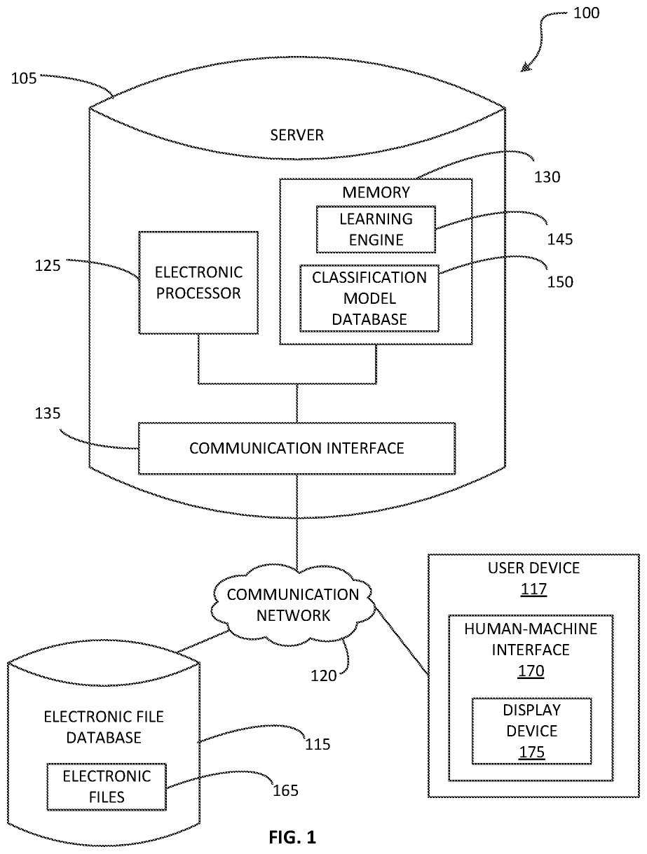

FIG. 1 schematically illustrates a system 100 for classifying content of an electronic file according to some embodiments. The system 100 includes a server 105, an electronic file database 115, and a user device 117. In some embodiments, the system 100 includes fewer, additional, or different components than illustrated in FIG. 1. For example, the system 100 may include multiple servers 105, multiple electronic file databases 115, multiple user devices 117, or a combination thereof. Also, in some embodiments, the electronic file database 115 may be included in the server 105 and one or both of the electronic file database 115 and the server 105 may be distributed among multiple databases or servers.

The server 105, the electronic file database 115, and the user device 117 communicate over one or more wired or wireless communication networks 120. Portions of the communication networks 120 may be implemented using a wide area network, such as the Internet, a local area network, such as Bluetooth™ network or Wi-Fi, and combinations or derivatives thereof. It should be understood that in some embodiments, additional communication networks may be used to allow one or more components of the system 100 to communicate. Also, in some embodiments, components of the system 100 may communicate directly as compared to through a communication network 120 and, in some embodiments, the components of the system 100 may communicate through one or more intermediary devices not shown in FIG. 1.

As illustrated in FIG. 1, the server 105 includes an electronic processor 125 (for example, a microprocessor, an application-specific integrated circuit (ASIC), or another suitable electronic device), a memory 130 (for example, a non-transitory, computer-readable medium), and a communication interface 135. The electronic processor 125, the memory 130, and the communication interface 135 communicate wirelessly, over one or more communication lines or buses, or a combination thereof. It should be understood that the server 105 may include additional components than those illustrated in FIG. 1 in various configurations and may perform additional functionality than the functionality described herein. For example, in some embodiments, the functionality described herein as being performed by the server 105 may be distributed among servers or devices (including as part of services offered through a cloud service), may be performed by one or more user devices 117, or a combination thereof.

The communication interface 135 allows the server 105 to communicate with devices external to the server 105. For example, as illustrated in FIG. 1, the server 105 may communicate with the electronic file database 115, the user device 117, or a combination thereof through the communication interface 135. The communication interface 135 may include a port for receiving a wired connection to an external device (for example, a universal serial bus (“USB”) cable and the like), a transceiver for establishing a wireless connection to an external device (for example, over one or more communication networks 120, such as the Internet, local area network (“LAN”), a wide area network (“WAN”), and the like), or a combination thereof.

The electronic processor 125 is configured to access and execute computer-readable instructions (“software”) stored in the memory 130. The software may include firmware, one or more applications, program data, filters, rules, one or more program modules, and other executable instructions. For example, the software may include instructions and associated data for performing a set of functions, including the methods described herein.

For example, as illustrated in FIG. 1, the memory 130 may store a learning engine 145 and a classification model database 150. In some embodiments, the learning engine 145 develops one or more classification model using one or more machine learning functions. Machine learning functions are generally functions that allow a computer application to learn without being explicitly programmed. In particular, the learning engine 145 is configured to develop an algorithm or model based on training data. For example, to perform supervised learning, the training data includes example inputs and corresponding desired (for example, actual) outputs, and the learning engine progressively develops a model (for example, a classification model) that maps inputs to the outputs included in the training data. Machine learning performed by the learning engine 145 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 145 to ingest, parse, and understand data and progressively refine models for data analytics.

Classification models generated by the learning engine 145 are stored in the classification model database 150. As illustrated in FIG. 1, the classification model database 150 is included in the memory 130 of the server 105. It should be understood, however, that, in some embodiments, the classification model database 150 is included in a separate device accessible by the server 105 (included in the server 105 or external to the server 105).

As illustrated in FIG. 1, the electronic file database 115 stores a plurality of electronic files 165 (referred to herein collectively as “the electronic files 165” and individually as “an electronic file 165”). An electronic file 165 may also be referred to herein as an electronic document. An electronic file 165 may include, for example, a word document, a text file, an electronic communication (for example, an email), a slideshow presentation, and the like. In some embodiments, the electronic files 165 may include multiple forms of content, such as text, one or more images, one or more videos, and the like.

The electronic files 165 stored in the electronic file database 115 include training data used by the learning engine 145. For example, the electronic files 165 may include files (word documents) acquired from one or more sources, such as the Internet. The sources for the electronic files included in the training data may be acquired from various sources including web pages, newspaper databases, legal document databases, research article databases, and the like. The training data may also be collected through word or content processing applications, such as telemetry data collected by these applications. Also, in some embodiments, the training set may be customized, such as by using tenant-specific (without a cloud environment) electronic files as the training data or user-specific electronic files. Similar customizations may also be performed at industry levels, geographic levels, and the like.

Before being used as training data, electronic files may be filtered. For example, electronic files may be filtered to identify files with labeled (user-labeled) content types and, in some embodiments, include particular content types, such as content labeled as a “Title” and content labeled as a “Heading.” Various length (characters, words, paragraphs, or pages) requirements may also be used to create a set of training data.

It should be understood that, in some embodiments, the electronic file database 115 is combined with the server 105. Alternatively or in addition, the electronic files 165 may be stored within a plurality of databases, such as within a cloud service. Furthermore, in some embodiments, the electronic files 165 may be stored in a memory of the user device 117. Although not illustrated in FIG. 1, the electronic file database 115 may include components similar to the server 105, such as an electronic processor, a memory, a communication interface and the like. For example, the electronic file database 115 may include a communication interface configured to communicate (for example, receive data and transmit data) over the communication network 120.

The user device 117 is a computing device and may include a desktop computer, a terminal, a workstation, a laptop computer, a tablet computer, a smart watch or other wearable, a smart television or whiteboard, or the like. Although not illustrated, the user device 117 may include similar components as the server 105 (an electronic processor, a memory, and a communication interface). The user device 117 may also include a human-machine interface 170 for interacting with a user. The human-machine interface 170 may include one or more input devices, one or more output devices, or a combination thereof. Accordingly, in some embodiments, the human-machine interface 170 allows a user to interact with (for example, provide input to and receive output from) the user device 117. For example, the human-machine interface 170 may include a keyboard, a cursor-control device (for example, a mouse), a touch screen, a scroll ball, a mechanical button, a display device (for example, a liquid crystal display (“LCD”)), a printer, a speaker, a microphone, or a combination thereof. As illustrated in FIG. 1, in some embodiments, the human-machine interface 170 includes a display device 175. The display device 175 may be included in the same housing as the user device 117 or may communicate with the user device 117 over one or more wired or wireless connections. For example, in some embodiments, the display device 175 is a touchscreen included in a laptop computer or a tablet computer. In other embodiments, the display device 175 is a monitor, a television, or a projector coupled to a terminal, desktop computer, or the like via one or more cables.

A user may use the user device 117 to create an electronic file. For example, the user device 117 may execute a word or content processing application (for example, Word® provided by Microsoft Corporation) that, when executed, allows a user to create new electronic files and modify existing electronic files, such as electronic documents. In some embodiments, the user device 117 may access a word or content processing application through a browser application or other portal application, wherein a server, such as the server 105 executes the word or content processing application in a hosted or cloud environment. Accordingly, electronic files managed (created or modified) by a user via the user device 117 may be stored locally on the user device 117 or remotely on a server, such as the server 105.

As noted above, when interacting with an electronic file, many users do not use document styling tools and borrow formatted content from a variety of sources, such as the Internet, other electronic files, other text files, and the like. This ultimately results in an electronic file having inconsistent formatting across portions of content included in the electronic file. To solve these and other problems, the system 100 is configured to classify content of an electronic file. In particular, the system 100 is configured to detect a content type associated with a portion of content included in an electronic file. The detected content type may be used to modify a format property in a consistent way, layout an electronic file more professionally, provide navigational guidelines within an electronic file, set one or more tags (for example, a title or an author) for an electronic file (or portions of content therein), or a combination thereof. As described above, the learning engine 145 creates a classification model for performing this content type detection.

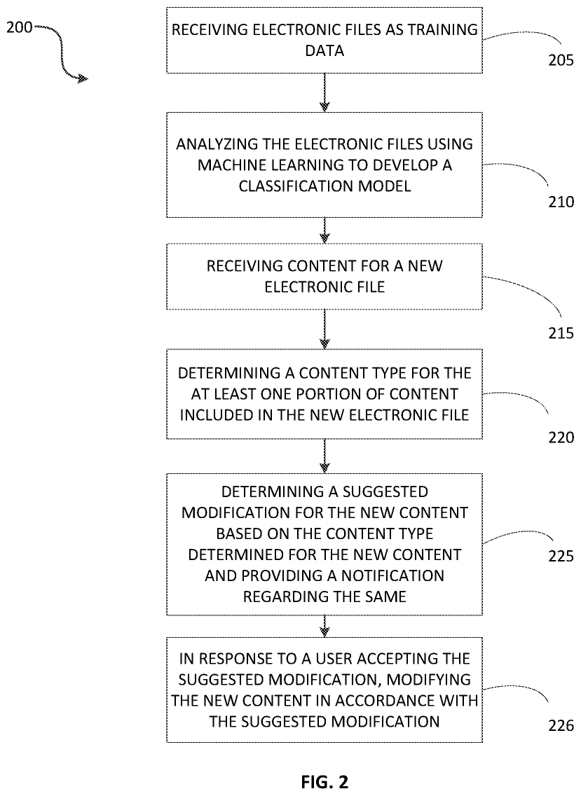

For example, FIG. 2 is a flowchart illustrating a method 200 for classifying content of an electronic file according to some embodiments. The method 200 is described herein as being performed by the server 105 (the electronic processor 125 executing instructions). However, as noted above, the functionality performed by the server 105 (or a portion thereof) may be performed by other devices, including, for example, the user device 117 (via an electronic processor executing instructions).

As illustrated in FIG. 2, the method 200 includes receiving, with the electronic processor 125, a plurality of electronic files 165 as training data (at block 205). In some embodiments, the electronic processor 125 receives the electronic files 165 via the communication interface 135 from the electronic file database 115 over the communication network 120. However, in some embodiments, the electronic files 165 or subsets thereof may be stored at additional or different databases, servers, devices, or a combination thereof. Accordingly, in some embodiments, the electronic processor 125 receives the electronic files 165 from additional or different databases, servers, devices, or a combination thereof.

As described above, the electronic files 165 received by the electronic processor 125 (at block 205) includes a plurality of portions of content associated with a plurality of content types. For example, one electronic file 165 may include a first portion of content (for example, “My Report”) associated with a first content type (associated with a first label or tag stored as metadata associated with the electronic file 165) identifying the first portion of content as a title of the electronic file 165 and a second portion of content (for example, “Introduction”) associated with a second content type identifying the second portion of content as a heading of the electronic file 165. In other words, the electronic files 165 received by the electronic processor 125 (at block 205) include a content type associated with (labeled for) one or more portion of content included in the electronic file 165.

After receiving the electronic files 165 (at block 205), the electronic processor 125 analyzes the electronic file 165 using machine learning to develop a classification model (at block 210). Although various machine learning techniques can be used, in some embodiments, the learning engine 145 uses a deep neural network (DNN) to train or generate a classification model. In some embodiments, the DNN includes the following layers: (a) an embedding layer, (b) two convolutional/max pooling layers, (c) a dropout layer, (d) a dense layer, and (e) a dense layer. An embedding layer is generally a mapping of discrete variables into a vector of continuous numbers (which provides a more manageable representation of content). A convolutional layer generally consists of a set of learnable filters. A max pooling layer is generally used to return/extract dominant features (a maximum value), such as the most important words or phrases in text. A dropout layer generally is a process of regularization to decrease overfitting. A dense layer generally connects all inputs directly to an output.

In some embodiments, multiple classification models may be developed, such as models for specific types of electronic files, specific groups of users (such as a tenant), a specific user, a specific industry, or the like. Also, in some embodiments, different classification models may be generated to analyze and classify an electronic file in real-time (for example, as a user types) than to analyze and classify an electronic file in a non-real-time situation, such as when a file is saved, opened, or at a user-request when additional content or modifications to content are not currently being made. Different training data may be used to create each of these models.

In some embodiments, classification models developed using machine learning and the electronic files 165 (at block 210) is stored in the classification model database 150 of the server 105. Alternatively or in addition, a classification model developed by the learning engine 145 may be stored in additional or different servers, databases, devices, or a combination thereof. For example, in some embodiments, a classification model developed via the learning engine 145 may be stored and used by a separate device, such as a separate server or the user device 117 in some embodiments.

As illustrated in FIG. 2, the method 200 also includes receiving, with the electronic processor 125, content for a new (not included as part of the training set) electronic file (at block 215) and determining, with the electronic processor, a content type for at least one portion of the content (at block 220). As noted above, a user may interact with (create, modify, and the like) an electronic file via the user device 117, such as through a content processing application stored on the user device 117 or accessible to the user device 117 in a hosted or cloud environment. A user may interact with an electronic file by, for example, adding new content, editing, existing content, or a combination thereof. As noted above, in many situations, a user adds new content to a file by copying and pasting content from one or more external sources (external to the content processing application), such as, for example, the Internet, other electronic files, other text files, or a combination thereof. When a user copies a portion of content (the new content) from a different source, the formatting of the new content may not be inconsistent with an existing or desired format of the electronic file (for example, a document theme or a document layout), one or more portions of content included therein, or a combination thereof.

The electronic processor 125 determines a content type for at least one portion of content included in the new electronic file using the previously-trained classification model (at block 220). A content type may include, for example, a body of text, a heading 1-n (for example, a heading 1, a heading 2, . . . a heading n), a document title, a subtitle, a byline, a header of abstract, an abstract, a list, source code, a “From” address, a “To” address, a signature, a quote, a bibliography, an emphasized text (including levels of emphasis, such as a subtle emphasis, a moderate emphasis, or an intense emphasis), a reference, a caption (such as a caption on an image, a table, a SmartArt element, and the like), a table of contents, a text box, a block of text, a footnote, an endnote, a date, a hyperlink, an ordered list, a content title (such as a title on an image, a table, a SmartArt element, a list, and the like) a hashtag, a citation, a definition, a sample, an example, a line number, a salutation, a glossary, a tagline, a headline, a preamble, or a closing.

In some embodiments, when determining a content type for a portion of content, the electronic processor 125 (via the trained classification model) analyzes text included in the portion of content. Thus, the classification model may be configured to analyze text in the new electronic file and determine (predict) a content type, such as a paragraph type, for portions of the text. For example, the classification model may be trained to identify particular terms or phrases in content, such as “in conclusion,” “as an introduction,” or the like. For example, the classification model can be trained with training data including text-based documents. In other embodiments, a classification model may be generated using other forms of content and is not limited to only processing text or text-based files. For example, the classification model may also be trained to identify images and associated captions in text. As another example, the classification model may also be trained to identify a format property (for example, bold, italics, a font size, a font weight, blank lines, color, and the like) and an associated portion of content. Furthermore, as described below, other factors may also be taken into account when determining a content type for a portion of content included in an electronic file. In some embodiments, these other factors may be applied by the classification model (for example, based on the training set used to train the model), by the electronic processor 125 applying the classification model (for example, as supplemental rules or factors combined with output from the model, or a combination thereof.

For example, in some embodiments, other portions of content included in the electronic file may be used to determine a content type for a particular portion of content. For example, in some embodiments, the electronic processor 125 (via the classification model) may use a predetermined number of portions (for example, up to five portions if available in some embodiments) before a portion, after a portion, or both. For example, as described above, in some embodiments the classification model may be applied in a real-time fashion as a user interacts with content within an electronic file (for example, to provide an as-you-type analysis). In this situation, the classification model may be configured to consider up to five previous portions of content. However, in other embodiments, a classification model may be applied in a non-real-time fashion and may be configured to consider one or more portions before a portion, after a portion, or both, including, in some situations, all available portions. The number and selection of other portions considered may be configured as needed to provide a desired level of accuracy as well as a desired speed of processing. The terms “previous” or “before” and “after” content” may reference an organization of content included in an electronic file according to a standard reading or viewing sequence of the content. For example, portions of a text-based electronic document occurring “before” a portion of content is positioned above the portion within a page of the document. Also, in some embodiments, the electronic processor 125 may use or switch between multiple models as an electronic file changes. For example, the electronic processor 125 may select a classification models to use from a plurality of available classification models based on a property of an electronic file. For example, depending on the amount of content within an electronic file, the electronic processor may select a classification model, such as either the real-time classification model or the non-real-time classification model. Also, as a property of the electronic files changes (as more content is added to the file), the electronic processor may switch between classification models. This switch may be requested by a user, may be performed automatically in response to currently detected file properties (such as length, number of portions, or the like), or a combination thereof.

In some embodiments, the electronic processor 125 also considers a position of a portion of content within an electronic file. For example, when a portion is at or near a top of a document, the portion may more likely be a “title” or an “abstract” content type as compared to portions at or near an end of the document (which may be more likely to be a “summary” or “bibliographic” content type). Accordingly, in some embodiments, especially when limited other portions of content are available for determining the content type of a portion of a file (such as when a user has just started adding or type content to a file), the electronic processor 125 may be configured to use the position of the portion as a factor when determining a content type and, in some embodiments, when a different content type cannot be determined with adequate confidence, a default content type may be determined for the portion, such as a “title” context type.

The electronic processor 125 (via the classification model) may also consider existing formatting properties or labels, including existing content types, such as, for example, a font property or a paragraph property. For example, the electronic processor 125 may determine the content type for a portion of content based on a font type, a font style, a font size, or a spacing of a portion of content preceding or following the new content. Similarly, if a user labeled a first paragraph of an electronic document as a “title” content type, the electronic processor 125 may use this type to determine a type for subsequent paragraphs, such as headings. In some embodiments, the electronic processor 125 may use existing content types solely to determine types for portions of content not associated with a content type. However, in other embodiments, the electronic processor 125 may use existing content types to determine suggested new content types for portions, such as to change an existing content type of a portion to a new content type that better matches an overall format of the file. For example, the electronic processor 125 may determine the content type for a subsequent portion of content based on a prior classification of a previous portion. For example, when a previous portion of content is determined to be “Heading 1” followed by another previous portion of content that is determined to be “Body Text,” the electronic processor 125 may be configured to determine a subsequent portion of content to be “Heading 2” (based on the previous portions of content being determined to be “Heading 1” and “Body of Text”).

In some embodiments, the electronic processor 125 may also consider other metadata about the electronic file (or a specific portion of content), such as, for example, a file type, a date created or modified, the user authoring or editing content, a geographical location of the user, how many modifications have been performed, how many users have interacted with the file, or the like. For example, by matching an author name to a name included in the content of a file, the electronic processor 125 can determine that the name included in the content could be labeled as an author type, which may be associated with particular formatting in some situations.

After determining the content type for a portion of content included in the new electronic file (at block 220), the electronic processor 125 determines a suggested modification for the new content based on the content type determined for the portion of content (at block 225). In some embodiments, the electronic processor 125 provides a notification of the suggested modification to a user of the user device 117 (for example, via the display device 175 of the user device 117). In response to the user accepting the suggested modification, the electronic processor 125 automatically modifies the portion of content in accordance with the suggested modification (at block 226). Alternatively or in addition, in some embodiments, the electronic processor 125 automatically applies the determined suggested modification with or without also notifying a user of the modification. In some embodiments, the electronic processor 125 prompts (via, for example, the notification of the automatically applied modification) or otherwise enables the user to accept or reject the automatically applied modification. For example, a user may revert or change the automatically applied modification when the modification was incorrect.

The suggested modification may include defining or labeling a portion as a particular content type, which may also impact or define a format property of the portion of content. In other words, defining a portion as a particular content type may automatically modify one or more format properties for the entire portion. In some embodiments, a format property includes a font property, such as a font type (for example, Times New Roman), a font size (for example, 12 point), a font style (for example, regular, bold, or italic), a font effect (for example, strikethrough, emboss, small caps, or subscript), an underline style, an underline color, a character scale (for example, 100% or 50%), a character spacing (for example, expanded or condensed), a font position (for example, normal, raised, or lowered), a font color, and the like. In some embodiments, the format property is a paragraph property, such as an alignment (for example, left or centered), an outline level, an indentation (for example, a right indent of 0.5″), a spacing (for example, double spaced), a list (for example, a numbered list, a bulleted list, or a multilevel list), and the like.

In some embodiments, a user may edit one or more format properties associated with a particular content type. When a user edits one or more format properties associated with a particular content type, the electronic processor 125 may automatically update one or more portions of content associated with the particular content type associated with the one or more edited format properties to reflect the one or more edited format properties. In other words, when a user changes a format property of a particular content type, other portions of content associated with that particular content type are automatically updated to reflect the changed format property such that all portions of content associated with the particular content type are consistently formatted. In some embodiments, a user edits one or more format properties associated with a particular content type in response to an automatically applied modification. Alternatively or in addition, a user may edit one or more format properties associated with a particular content type by editing one or more default format properties associated with that particular content type.

Alternatively or in addition, in some embodiments, the suggested modification may include a modification to an arrangement of one or more portions of content included in a new electronic file. For example, when the new content is determined to be a content type representing a “title,” the electronic processor 125 may apply the suggested modification by moving the new content to a top portion of the new electronic file. In other words, in some instances, applying the suggested modification includes re-arranging one or more portions of content included in the new electronic file.

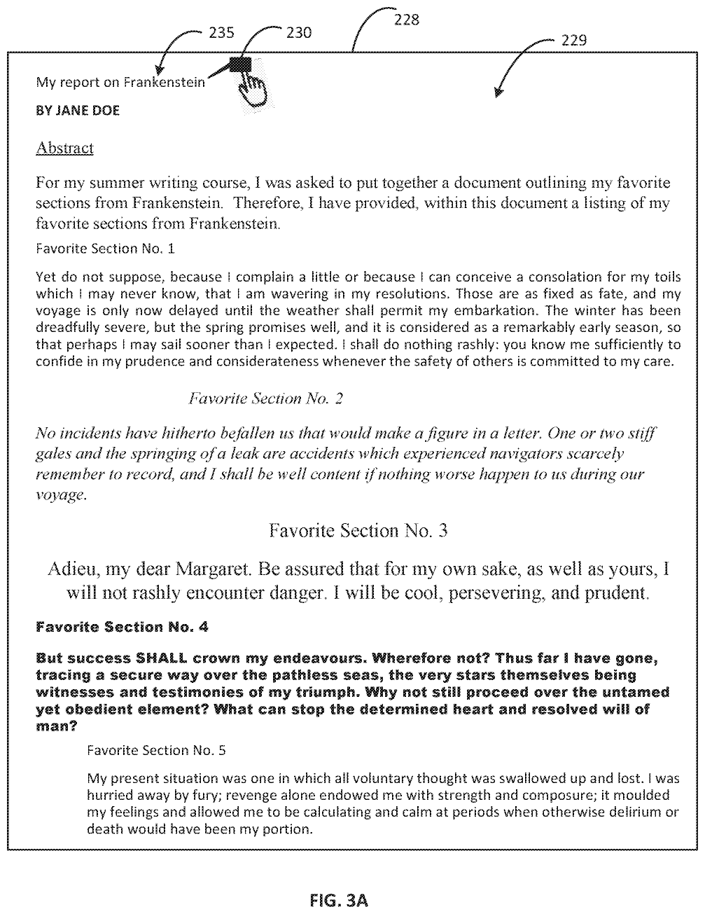

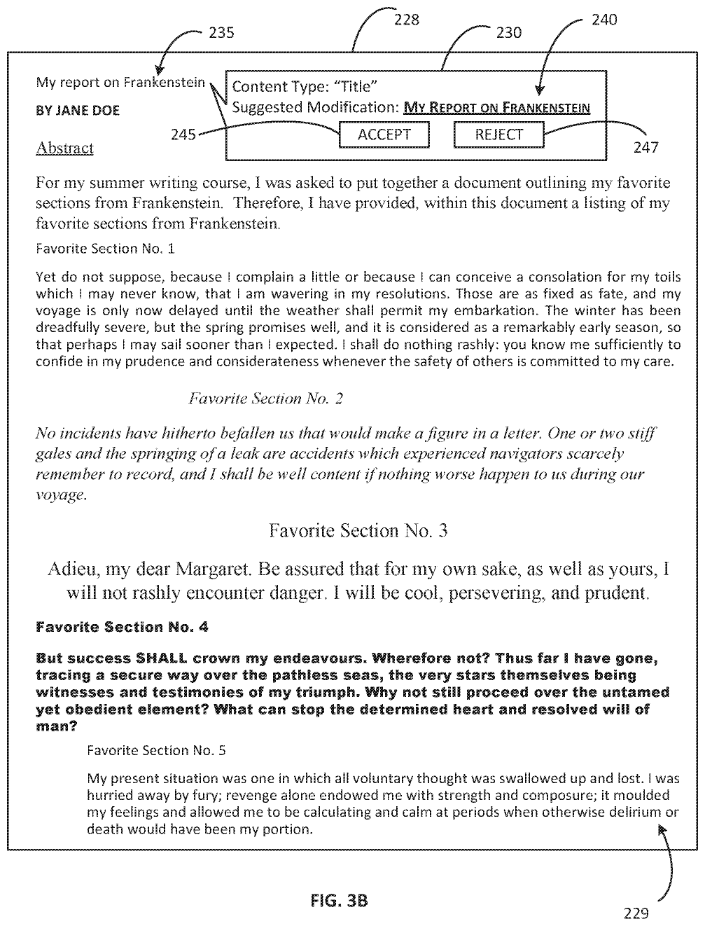

In some embodiments, the electronic processor 125 provides the notification regarding the suggested modification within the new electronic file (within a canvas displaying a rendering of the electronic file). For example, the electronic processor 125 may provide a notification of the suggested modification as an indicator within a body portion of the electronic file. For example, FIG. 3A illustrates an electronic file 228 having inconsistent formatting across a plurality of portions of content included in a body portion 229 of the electronic file 228. As seen in FIG. 3A, the electronic file 228 includes an indicator 230 indicating that there is a suggested modification for a portion of content 235 (the new content). The indicator 230 is visually associated with the portion of content 235 based on its position or orientation. A user may interact with (via an input mechanism of the user device 117) the indicator 230. For example, a user may hover over or select the indicator 230. In response to a user interaction, the indicator 230 may provide additional information to the user relating to the suggested modification. For example, as illustrated in FIG. 3B, the additional information provided to the user may include, for example, a visual preview 240 of the suggested modification applied to the portion of content 235, a content type determined for the portion of content 235, and the like. The user may further interact with the additional information, such as accepting the suggested modification via an accept mechanism 245 or rejecting the suggested modification via a reject mechanism 247. Accordingly, in some embodiments, in response to receiving a user interaction with the indicator 230, the electronic processor 125 provides a visual preview 240 of the new content with the suggested modification applied to the new content and prompts the user to accept or reject the suggested modification (via one or more input mechanisms).

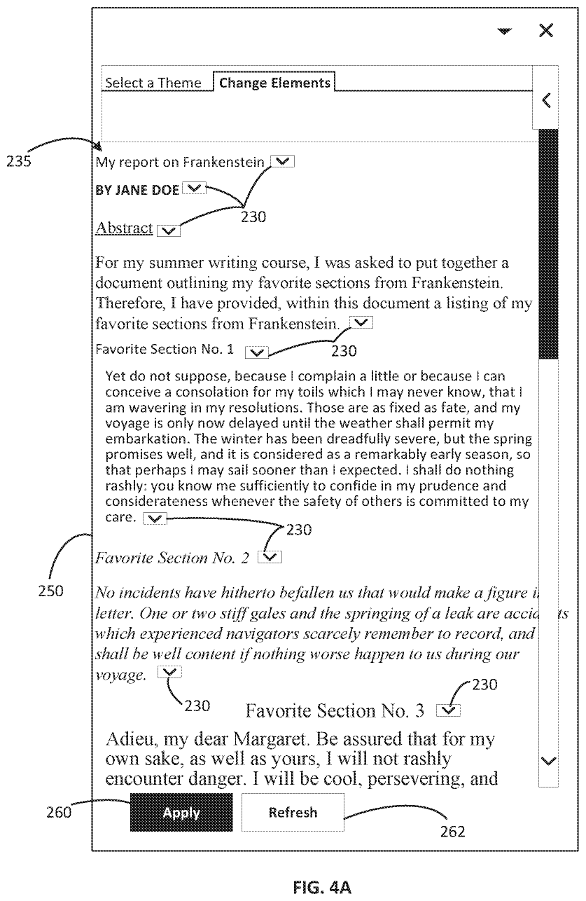

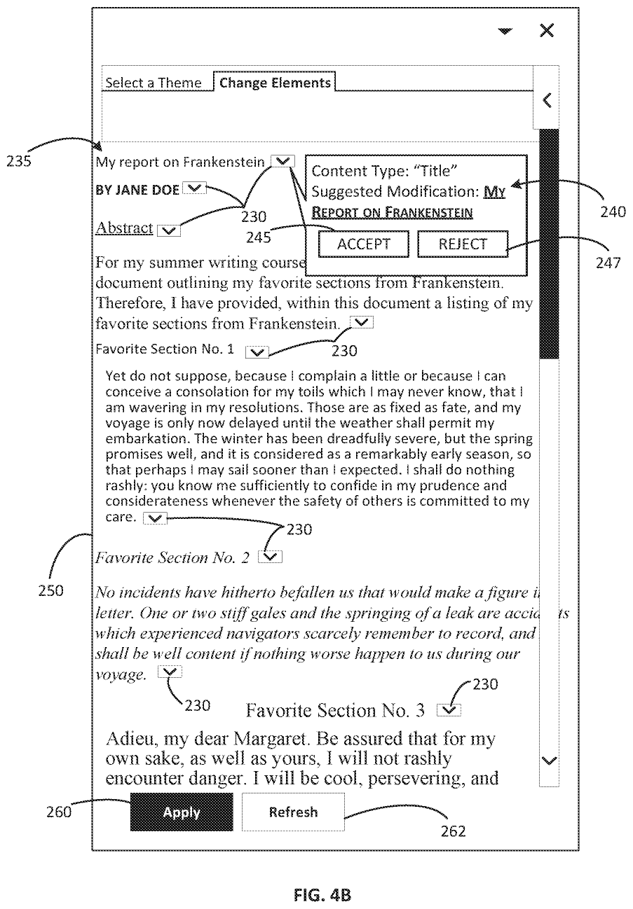

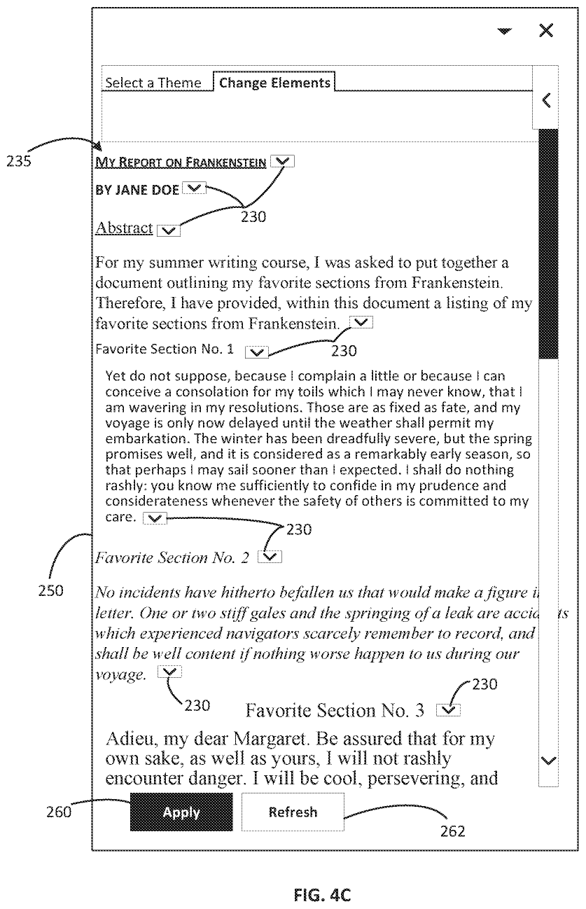

Alternatively or in addition, the electronic processor 125 provides a notification regarding a suggested modified within a graphical user interface (for example, a side panel) separate from the body portion 229 of an electronic file. For example, FIG. 4A illustrates a graphical user interface (GUI) 250. As seen in FIG. 4A, the GUI 250 includes a plurality of indicators 230. Each indicator 230 may indicate a suggested modification for a corresponding portion of content (for example, the portion of content 235). Accordingly, as illustrated in FIG. 4A, each indicator 230 is visually associated with a corresponding portion of content by being positioned adjacent to in proximity to the associated portion of content. As noted above, a user may interact with (via an input mechanism of the user device 117) an indicator 230. For example, a user may hover over or select the indicator 230. In response to a user interaction, the indicator 230 may provide additional information to the user relating to the suggested modification. For example, as illustrated in FIG. 4B, the additional information provided to the user may include, for example, the visual preview 240 of the suggested modification applied to the portion of content 235, a content type of the portion of content 235, and the like. The user may further interact with the additional information, such as accepting the suggested modification via an accept mechanism 245 or rejecting the suggested modification via a reject mechanism 247. Accordingly, in some embodiments, in response to receiving a user interaction with the indicator 230, the electronic processor 125 provides a visual preview 240 of the new content with the suggested modification applied to the new content and prompts the user to accept or reject the suggested modification (via one or more input mechanisms).

In some embodiments, as illustrated in FIG. 4C, the electronic processor 125 only applies the suggested modification to the portion of content 235 displayed within the GUI 250 in response to a user accepting the suggested modification (via the accept mechanism 245). Accordingly, before the suggested modification is applied to the actual portion of content included in an electronic file, the suggested modification is only applied within a preview of the GUI 250, as seen in FIG. 4C. This allows a user to interact with a plurality of portions of content through the GUI 250 and see a plurality of suggested modifications applied to corresponding portions of content displayed within the GUI 250 prior to applying any suggested modification to an actual portion of content included in an electronic file. When a user is satisfied with the preview of displayed within the GUI 250, a user may apply all of the suggested modifications accepted via the GUI 250 to the corresponding one or more actual portions of content included in an electronic file by actuating an apply mechanism 260 of the GUI 250. In some embodiments, a user may actuate a refresh mechanism 262 to refresh the preview displayed within the GUI 250. For example, in response to actuating a refresh mechanism 262 of the GUI 250, any changes that the user made to the actual portions of content included in the electronic file will be reflected in the preview displayed within the GUI 250. In other embodiments, the preview displayed within the GUI 250 is automatically updated (in real time or near real time) to reflect any changes that the user made to the actual portions of content included in the electronic file. In other words, the preview displayed within the GUI 250 is kept up-to-date with the body portion 229 of the electronic file as a user interacts with the electronic file (for example, as the user types in the body portion 229 of the electronic file).

Alternatively or in addition, in some embodiments, the electronic processor 125 provides a plurality of suggested modifications (for example, a second suggested modification, a third suggested modification, and the like). In some embodiments, the plurality of suggested modifications are suggested modifications for the same portion of content, for different portions of content, or a combination thereof. For example, a first suggested modification may be a modification to a paragraph property of the new content and a second suggested modification may be a modification to a font property of the new content. As another example, a first suggested modification may be a modification to the new content and a second suggested modification may be a modification to a different portion of content. As yet another example, a first suggested modification may be a modification to a font property of the new content, a second suggested modification may be a modification to a paragraph property of the new content, and a third suggested modification may be a modification to a font property of a different portion of content. Also, in some embodiments, suggested modifications may represent alternatives for the same content, such as two different font properties.

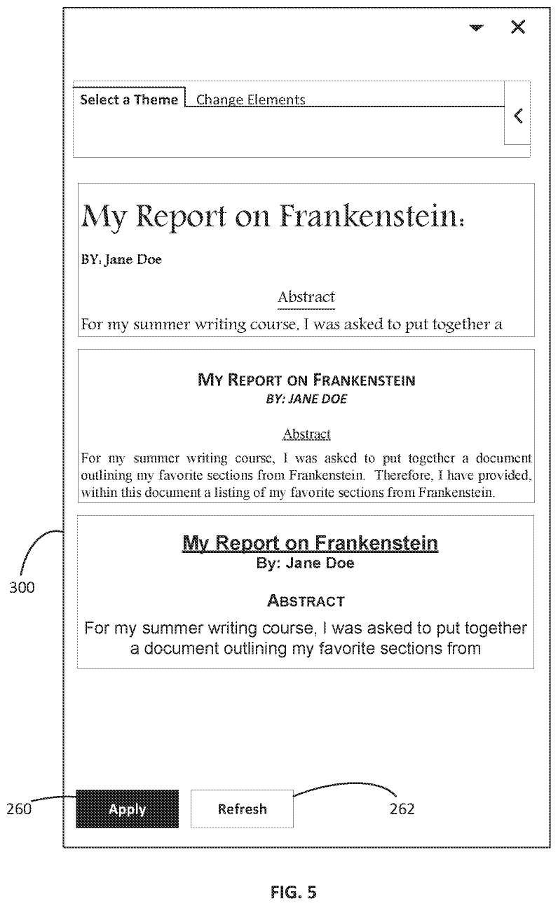

Similarly, the suggested modification may be a modification associated with more than one portion of content of the new electronic file. For example, in some embodiments, the suggested modification is associated with all portions of content included in the new electronic file. Accordingly, when the electronic processor 125 applies the suggested modification, the electronic processor 125 applies the suggested modification to all portions of content included in the new electronic file. For example, in some situations, the suggested modification may be to apply a particular document layout or document theme. As illustrated in FIG. 5, the electronic processor 125 may provide the suggested modification in this situation (for example, as one or more suggested document layouts or theme) in a GUI 300. As illustrated in FIG. 5, the GUI 300 provides a preview for applying each suggested layout or theme and the user can select one of the previews and the accept mechanism 260 to apply the suggested layout or them to the electronic file.

In some embodiments, suggested modifications provided by the electronic processor 125 are updated as a user interacts with an electronic file. For example, the electronic processor 125 may detect a first user interaction with the electronic file, such as adding a new portion of content to an electronic file or providing a user-selected content type for a portion of existing content. In response, the electronic processor 125 may determine a content type associated with the new portion of new content and provide a suggested modification based on the determined content type. In some embodiments, the electronic processor 125 may also adjust one or more previously-provided suggested modifications based on the content type or suggestions provided in response to user interactions. For example, when the electronic processor 125 determines that a new portion of content likely represents a title of a document, the electronic processor 125 may update a previously-provided suggested modification to format other content as the title. Accordingly, the electronic processor 125 may continuously monitor an electronic file for additional user interactions (second interaction, third interaction, and the like) and update the suggested modifications accordingly. In some embodiments, the updated suggested modification may be a new suggested modification (for example, for the new portion of content), a revised suggested modification, or a combination thereof.

In some embodiments, when the electronic processor 125 determines a content type for a portion of content of an electronic file, the electronic processor 125 may set (automatically or in response to user confirmation) one or more tags associated with file, which may be the same tag set when a user manually defines a content type for a portion of content. Each tag may apply to a portion of content or the entire file. For example, the electronic processor 125 may use the classification model to determine and set a “Title” tag to a portion of content determined to be a title (a content type) of an electronic file. As another example, the electronic processor 125 may use the classification model to determine and set a “Resume” tag for an electronic file in response to determining that the electronic file is a resume (a content type).

In some embodiments, the one or more tags to provide document navigational functionality, document searching functionality, or a combination thereof to a user interacting with the electronic file. In other words, using the one or more tags associated with one or more portions of content included in an electronic file, a user may, for example, easily search for a “title” of the electronic file or navigate to a “signature block” of the electronic file. For example, in some embodiments, a user can issue a search inquiry within a content processing application and the tags are used to provide search results, such as portions of content having a searched-for content type. Accordingly, a user can quickly identify different types included in an electronic file. Furthermore, these tags can be used for navigational functionality within an electronic file.

In some embodiments, determined content types, suggested modifications, or both may also be determined based on user input. For example, the electronic processor 125 may prompt a user to provide information regarding the type of an electronic file (for example, resume, letter of intent, cover letter, book, or the like), which the electronic processor 125 uses to determine a content text, determined a suggested modification, or both. In some embodiments, the prompts to the user, selectable options for responding to the prompts, or both may be initially determined by the electronic processor 125 using the classification model as described above. Accordingly, although user input is being requested, the input is focused or tailored, meaning that a user may be more willing to provide the input.

In some embodiments, the electronic processor 125 updates the classification model based on whether a user accepts or rejects a suggested modification. In other words, the electronic processor 125 may monitor or track a user's interaction with a suggested modification and may use the user's interaction with the suggested modification as feedback data for updating the classification model. Alternatively or in addition, the electronic processor 125 may update the classification model based on one or more user-determined content types for one or more portions of content included in the electronic file.

As described above, suggested modifications can be automatically applied or applied in response to a user's acceptance of the suggested modification. For example, in some embodiments, the electronic processor 125 operates in one of three modes. In an automatic mode, suggested modifications are automatically applied without receiving prior acceptance from a user. However, in some embodiments, notifications are provided to a user after automatically applying a suggested modification to provide a user with information regarding the modification and, optionally, why the modification was made. In a pop-up mode, the electronic processor 125 may automatically and continuously process content within an electronic file and provide various pop-ups, indicators, or other information, such as directly within the file as displayed, of suggested modifications that a user can ignore, accept, or decline. In a third mode, a user is required to request processing of content within an electronic file and results of the analysis may be provided within or in a separate window or pane than the file for user review and acceptance. In some embodiments, different mode may be used for different suggested modifications. For example, in some embodiments, the classification model used to analyze the content may be configured to not only determine a suggested modification by to also determine a confidence level or score for the suggested modification (representing a likelihood that the suggested modification is appropriate for the content and, thus, would be acceptable to a user). This confidence score can be used to determine whether to automatically apply the suggested modification, generate a pop-up or other notification regarding the suggested modification, or wait for the user to request analysis and suggested modifications. Various thresholds can be configured (by a user or administrator) regarding the confidence scores and the thresholds may vary for different users or groups of users, different types of files, different content types, different types of suggested modifications, or the like. The thresholds may also be updated or adjusted based on feedback, such as whether a user commonly ignores pop-up notifications for particular types of suggested modifications, always accepts particular types of modifications, or the like.

Thus, embodiments described herein provide, among other things, systems and methods for classifying content of an electronic file, and, more particularly, for detecting a content type associated with a portion of content included in an electronic file and providing a suggested modification for the portion of content based on the content type associated with the portion of content. By classifying content of an electronic file, content type information may be provided to a user, which allows a user to apply one or more suggested modifications to a specific portion of content, browse multiple suggested modifications or document themes and apply a suggested modification or document theme to all portions of content included in the electronic file, or a combination thereof. Accordingly, embodiments described herein provide users with a productivity boost by helping them design professional and engaging electronic files and are used to create higher quality files which not only aid a user's interaction with the file but also create files better suited for searching, mining, machine learning processes, and other automated processing. Accordingly, the methods and systems described herein use machine learning to develop a classification model configured to, in some embodiments, obtain a semantic understanding of content (beyond just formatting), which allows various themes and other organizational layouts and concepts to be applied to the file to create richer, more useful files by both users and computing systems.

It should be understood that the methods and systems described herein related to a hosted or cloud environment wherein processing of content included in an electronic file is performed at a server as compared to locally on a user device. However, the methods and systems described herein are equally usable in a local configuration, wherein a classification model is locally installed on a user device and used to process content within electronic files also stored locally on the user device. In some embodiments, different classification models can also be created for different processing configurations, such as whether the classification model is applied by a server in a cloud environment or locally by a user device to account for processing and memory capabilities.

Various features and advantages of some embodiments are set forth in the following claims.

What is claimed is:

1. A system for classifying content of an electronic file, the system comprising:
an electronic processor configured to
determine a content type associated with a portion of content included in the electronic file using a classification model developed using machine learning,
determine a suggested modification for the portion of content based on the determined content type, wherein the suggested modification is a modification to a format property of the portion of content,
provide a notification of the suggested modification to a user for acceptance of the suggested modification, and
in response to the user accepting the suggested modification, modifying the format property of the portion of content in accordance with the suggested modification.

2. The system of claim 1, wherein the electronic processor is configured to generate the classification model using machine learning using a training set, the training set including a plurality of electronic files, wherein one or more portions of content included in each of the plurality of electronic files is associated with one of a plurality of content types.

3. The system of claim 1, wherein the electronic processor is configured to determine the content type associated with the portion of content by analyzing text included in the portion of content.

4. The system of claim 1, wherein the electronic processor is configured to determine the content type associated with the portion of content by analyzing text included in another portion of content included the electronic file.

5. The system of claim 1, wherein the electronic processor is configured to determine the content type associated with the portion of content by analyzing at least one selected from a group consisting of a predetermined number of other portions of content included in the electronic file before the portion of content and a predetermined number of other portions of content included in the electronic file after the portion of content.

6. The system of claim 1, wherein the electronic processor is configured to determine the content type associated with the portion of content by analyzing formatting of the portion of content.

7. The system of claim 1, wherein the electronic processor is configured to determine the content type associated with the portion of content while the user adds the portion of content to the electronic file.

8. The system of claim 1, wherein the electronic processor is configured to update the classification model based on whether the user accepts or rejects the suggested modification.

9. The system of claim 1, wherein the electronic processor is configured to determine the content type associated with the portion of content based on formatting of one or more portions of content included in the electronic file before or after the portion of content.

10. The system of claim 1, wherein the electronic processor is configured to determine the content type associated with the portion of content based on a user-assigned content type associated with another portion of content included in the electronic file.

11. The system of claim 1, wherein the electronic processor is configured to select the classification model from a plurality of classification models based on a property of the electronic file.

12. The system of claim 1, wherein the electronic processor is configured to provide the notification of the suggested modification by displaying an indicator within a body portion of the electronic file, wherein the indicator is visually associated with the portion of content.

13. The system of claim 12, wherein the electronic processor is further configured to, in response to receiving a user interaction with the indicator, provide a visual preview of the portion of content with the suggested modification and a prompt to accept or reject the suggested modification.

14. The system of claim 1, wherein the electronic processor is configured to provide the notification of the suggested modification by displaying the suggested modification in a panel separate from a body portion of the electronic file, wherein the suggested modification displayed in the panel provides a visual preview of the portion of content with the suggested modification applied.

15. A method for classifying content of an electronic file, the method comprising:
receiving, with an electronic processor, a training set, the training set including a plurality of electronic files, wherein one or more portions of content included in each of the plurality of electronic files is associated with one of a plurality of content types;
generating, with the electronic processor, a classification model using machine learning and the training set;
receiving, with the electronic processor, a new electronic file;
determining, with the electronic processor, a content type for a portion of content included in the new electronic file using the classification model;
determining, with the electronic processor, a suggested modification for the portion of content based on the content type;
providing, with the electronic processor, a notification of the suggested modification to a user for acceptance of the suggested modification; and
in response to the user accepting the suggested modification, modifying the portion of content in accordance with the suggested modification.

16. The method of claim 15, further comprising:
receiving a user input indicating a file type of the electronic file, and
wherein determining the content type for the portion of content included in the new electronic file includes determining the content type using the classification model and the file type.

17. A non-transitory, computer-readable medium including instructions, that when executed by an electronic processor, perform a set of functions, the set of functions comprising:
detecting a user interaction with an electronic file by a user, wherein the user interaction includes adding a portion of content to the electronic file;
in response to detecting the user interaction, applying a real-time classification model developed using machine learning to determine a content type associated with the portion of content;
determining a modification for the portion of content based on the content type; and
applying the modification to the portion of content.

18. The computer-readable medium of claim 17, wherein applying the modification to the portion of content includes applying the modification in response to receiving an acceptance of the modification from the user.

19. The computer-readable medium of claim 18, further comprising:
setting one or more tags associated with the portion of content based on the content type.

20. The computer-readable medium of claim 18, wherein the modification includes at least one of changing a formatting parameter of the portion of content and changing a position of the portion of content within the electronic file.
